(19) United States
(12) Patent Application Publication
(10) Pub. No.: US 2015/0067056 A1
(43) Pub. Date: Mar. 5, 2015

(54) INFORMATION PROCESSING SYSTEM, INFORMATION PROCESSING APPARATUS, AND INFORMATION PROCESSING METHOD

(71) Applicant: Maki YAMAGIWA, Kanagawa (JP)

(72) Inventor: Maki YAMAGIWA, Kanagawa (JP)

(73) Assignee: RICOH COMPANY, LTD., Tokyo (JP)

(21) Appl. No.: 14/453,850

(22) Filed: Aug. 7, 2014

(30) Foreign Application Priority Data
Aug. 27, 2013 (JP) 2013-175785

(51) Int. Cl. H04L 29/06

(52) U.S. Cl. CPC H04L 65/403
USPC 709/204

(57) ABSTRACT

Disclosed is an information processing apparatus connected via a network to a display apparatus and one or more operations terminals. The information processing apparatus includes a display controller configured to transmit to the display apparatus and the operations terminals image data in which at least one object is disposed and display the transmitted image data on the display apparatus and the operations terminals, an information manager configured to manage information of the objects, and a display update unit configured to update a display of the objects disposed in the image data by receiving operations with respect to the objects from the operations terminals and updating the objects based on the received operations.

### BACKGROUND OF THE INVENTION

1. Field of the Invention

The disclosures discussed herein generally relate to an information processing system, an information processing apparatus, and an information processing method.

2. Description of the Related Art

There are known in the related art electronic conference systems capable of conducting an electronic conference by simultaneously utilizing screen sharing software for allowing all the attendees at the electronic conference to browse electronic materials in real time, and application software for allowing the attendees to write characters or drawings associated with content items of discussions (e.g., Patent Document 1).

Some of the conference methods include a brainstorming technique by which each of the attendees of the conference is encouraged to provide ideas for gathering a large number of ideas. The related art electronic conference system is suitable for a conference method where a presenter of the conference gives a presentation, and it may be more useful to have an electronic conference system by which two or more attendees of the conference are capable of electronically providing ideas to discuss their ideas.

Similar to such an electronic conference system proposed above, it may be desirable to have an information processing system by which two or more users are capable of providing information to discuss the provided information.

### RELATED ART DOCUMENTS

### Patent Document

Patent Document 1: Japanese Laid-open Patent Publication No. 2006-164177

### SUMMARY OF THE INVENTION

Accordingly, it is a general object in one embodiment of the present invention to provide an information processing system, an information processing apparatus, and an information processing method suitable for allowing two or more users to provide information to discuss the provided information that substantially obviates one or more problems caused by the limitations and disadvantages of the related art.

In one aspect of the embodiment, there is provided an information processing apparatus connected via a network to a display apparatus and one or more operations terminals. The information processing apparatus includes a display controller configured to transmit to the display apparatus and the operations terminals image data in which at least one object is disposed and display the transmitted image data on the display apparatus and the operations terminals; an information manager configured to manage information of the objects; and a display update unit configured to update a display of the objects disposed in the image data by receiving operations with respect to the objects from the operations terminals and updating the objects based on the received operations.

Other objects, features and advantages of the present invention will become more apparent from the following detailed description when read in conjunction with the accompanying drawings.

### BRIEF DESCRIPTION OF THE DRAWINGS

FIG. 1 is a configuration diagram illustrating an example of a conference system according to an embodiment;

FIG. 2 is a hardware configuration diagram illustrating an example of the conference system according to the embodiment;

FIG. 3 is a functional block diagram illustrating an example of the conference system according to the embodiment;

FIG. 4 is a configuration diagram illustrating an example of conference information stored in a registered information DB;

FIG. 5 is a configuration diagram illustrating an example of material information stored in the registered information DB;

FIG. 6 is an image diagram illustrating an example of a display of new conference content;

FIG. 7 is a screen image diagram illustrating a transmission process of a file that is desired to be displayed on the new conference content;

FIG. 8 is a screen image diagram illustrating an example of an imaged screen;

FIG. 9 is a screen image diagram illustrating an example of a selection screen for selecting a folder;

FIG. 10 is a screen image diagram illustrating an example of a selection screen for selecting a file;

FIG. 11 is a flowchart illustrating an example of a process of creating new conference content;

FIG. 12 is a flowchart illustrating an example of a transmission and saving process of content in the image file of the new conference content;

FIG. 13 is a flowchart illustrating an example of an addition and saving process of a drawing object in the image file of the new conference content; and

FIG. 14 is a sequence diagram illustrating an example of exclusive control over operations with respect to an object.

### DETAILED DESCRIPTION OF THE PREFERRED EMBODIMENTS

Next, a detailed description is given of an embodiment. Note that in the following embodiment, a conference system is illustrated as an example of an information processing system. The present embodiment may implement a conference system suitable for a conference method such as brainstorming in which attendees of the conference provide ideas to discuss the provided ideas. A conference system according to an embodiment may be able to electronically implement a conference similar to a non-electronic conference in which two or more users are able to provide their ideas on post-it stickers attached to the whiteboard and discuss their ideas by moving or grouping the post-it stickers, and additional writing of ideas on the white board.

### FIRST EMBODIMENT

### System Configuration

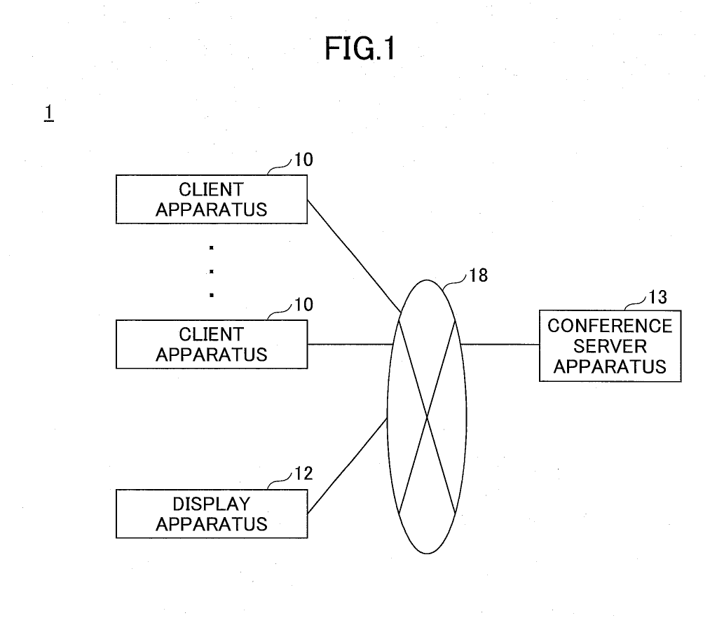

FIG. 1 is a configuration diagram illustrating an example of a conference system according to an embodiment. As illustrated in FIG. 1, a conference system 1 according to an embodiment includes one or more client apparatuses 10, a display apparatus 12, and a conference server apparatus 13 that are connected via a wired or wireless network 18.

Note that the conference server apparatus 13 may be implemented by software or a service that operates on a computer. For example, the conference server apparatus 13 may be implemented by a cloud service.

The client apparatus 10 is an operations terminal that is operated by a user. Examples of the client apparatus 10 include mobile information terminals such as a personal computer (PC), a tablet terminal, a smartphone, a mobile phone, and a personal digital assistant.

Examples of the display apparatus include an electronic whiteboard, a large-scale monitor, and the like. The conference server apparatus 13 is configured to perform information processing associated with a conference. Examples of the conference server apparatus 13 include a workstation (WS), a PC, and the like.

The client apparatus 10 has installed a conference application for creating and displaying conference information, documents (conference materials), and other information associated with a conference. The display apparatus 12 is configured to display a screen of the conference similar to that of the client apparatus 10. Input to the display apparatus 12 may be performed via a touch panel or a special pen.

The conference server apparatus 13 is configured to archive registered conference information. Further, the conference server apparatus 13 is configured to manage statuses of a conference while the conference is in progress. The conference server apparatus 13 is configured to archive content items of registered documents and document information.

The client apparatus 10 is configured to display a client-use screen or a conference management screen of the conference system 1. For example, when receiving operations (personal memos, etc.) associated with conference materials of users attending a conference, the client apparatus 10 saves the operations associated with the conference materials as a file in a temporary saving area.

When saving the operations associated with the conference materials finally in the conference server apparatus 13, the client apparatus 10 transmits a communications request to the conference server apparatus 13. When the communications are established, the client apparatus 10 transmits the file to the conference server apparatus 13. The conference server apparatus 13 saves the file received from the client apparatus 10 together with the conference information and user information.

### Hardware Configuration

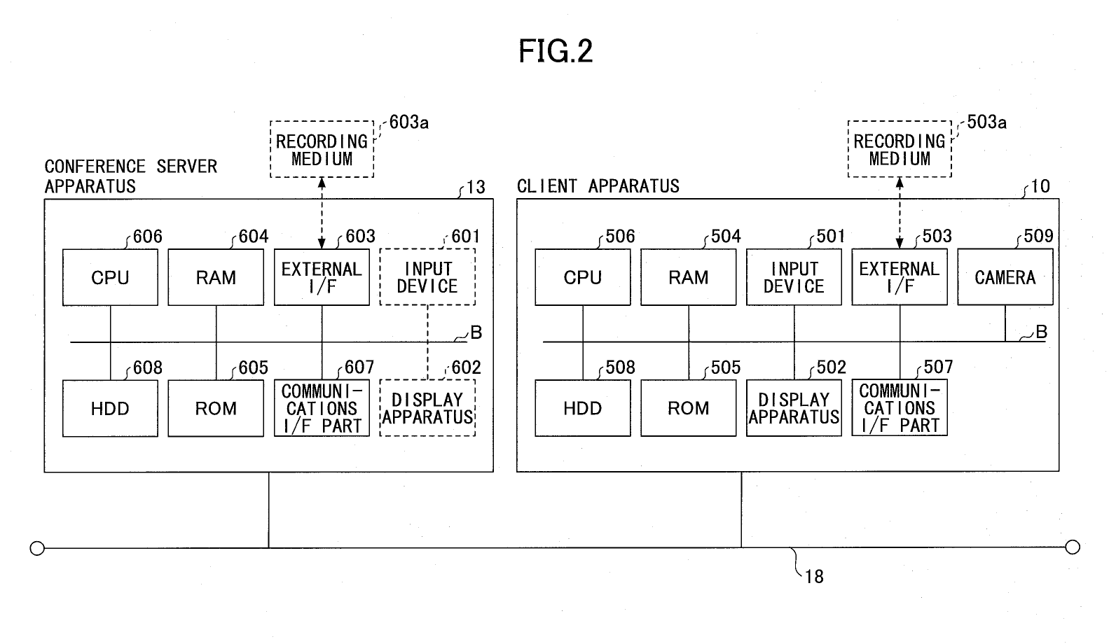

The client apparatus 10, the display apparatus 12, and the conference server apparatus 13 may be implemented by a hardware configuration illustrated in FIG. 2.

FIG. 2 is a hardware configuration diagram illustrating an example of the conference system according to the embodiment. As illustrated in FIG. 2, the client apparatus 10 includes an input device 501, a display apparatus 502, an external I/F 503, a random access memory (RAM) 504, a read-only memory (ROM) 505, a central processing unit (CPU) 506, a communications I/F 507, a hard disk drive (HDD) 108, a camera 509, and the like that are connected to one another via a bus B. Note that the client apparatus 10 may be configured to include a microphone and a speaker.

The input device 501 includes a keyboard, a mouse, and a touch panel, and is configured to input various operation signals into the client apparatus 10. The display apparatus 502 includes a display, and the like, and is configured to display a result of a process executed by the client apparatus 10. The communications I/F 507 serves as an interface configured to connect the client apparatus 10 to a network 18. Hence, the client apparatus 10 may be able to perform data communications with the conference server apparatus 13 via the communications I/F 507. The camera 509 is configured to provide an imaging function.

The HDD 508 serves as a non-volatile storage device configured to store programs and data. Examples of the stored programs and data include an operating system (OS) serving as basic software that is configured to control the client apparatus 10 as a whole, application software that is configured to provide various functions on the OS, and the like. Further, the HDD 508 is configured to manage the stored programs and data in a predetermined file system and/or a DE.

The external I/F 503 servers as an interface with respect to external devices. Examples of the external devices include a recording medium 503a, and the like. Hence, the client apparatus 10 may be able to read the recording medium 503a or write on the recording medium 503a via the external I/F 503. Examples of the recording medium 503a include a flexible disk, a compact disk (CD), a digital versatile disk (DVD), a secure digital (SD) card, universal serial bus (USB) memory, and the like.

The ROM 505 is a non-volatile semiconductor memory (a storage device) configured to retain programs or data even when power supply is turned off. The ROM 505 is configured to store programs and data such as BIOS that is executed at startup of the client apparatus 10, OS settings, network settings, and the like. The RAM 504 is a volatile semiconductor memory configured to temporarily store programs and data.

The CPU 506 is a processor configured to implement control over entire hardware of the client apparatus 10 or functions of the client apparatus 10 by loading programs and data in the RAM 504 from a storage device such as the ROM 505 and the HDD 508 and executing processes.

The client apparatus 10 may be able to implement later-described various processes by executing programs in the above-described hardware configuration.

As illustrated in FIG. 2, the conference server apparatus 13 includes an input device 601, a display apparatus 602, an external I/F 603, a RAM 604, a ROM 605, a CPU 606, a communications I/F 607, an HDD 608, and the like that are connected to one another via a bus B. Note that the input device 601 and the display apparatus 602 may optionally be connected when they are necessary.

The input device 601 includes a keyboard and a mouse, and is configured to input various operation signals into the conference server apparatus 13. The display apparatus 602 includes a display and the like, and is configured to display a result of a process executed by the conference server apparatus 13.

The communications I/F 607 serves as an interface configured to connect the conference server apparatus 13 to the network 18. Hence, the conference server apparatus 13 may be able to perform data communications with the client apparatus 10 via the communications I/F 607.

The HDD 608 serves as a non-volatile storage device configured to store programs and data. Examples of the stored programs and data include an operating system (OS) serving as basic software that is configured to control the conference server apparatus 13 as a whole, application software that is configured to provide various functions on the OS, and the like. Further, the HDD 608 is configured to manage the stored programs and data in a predetermined file system and/or a DB.

The external I/F 603 servs as an interface with respect to external devices. Examples of the external devices include a recording medium 603a, and the like. Hence, the conference server apparatus 13 may be able to read the recording medium 603a or write on the recording medium 603a via the external I/F 603. Examples of the recording medium 603a include a flexible disk, a compact disk (CD), a digital versatile disk (DVD), a secure digital (SD) card, universal serial bus (USB) memory, and the like.

The ROM 605 is a non-volatile semiconductor memory (a storage device) configured to retain programs or data even when power supply is turned off. The ROM 605 is configured to store programs and data such as BIOS that is executed at startup of the conference server apparatus 13, OS settings, network settings, and the like. The RAM 604 is volatile semiconductor memory configured to temporarily store programs and data.

The CPU 606 is a processor configured to implement control over the conference server apparatus 13 or functions of the conference server apparatus 13 by loading programs and data in the RAM 605 from a storage device such as the ROM 608 and the HDD 604 and executing processes.

The conference server apparatus 13 may be able to implement later-described various processes by executing programs in the above-described hardware configuration.

### Software Configuration

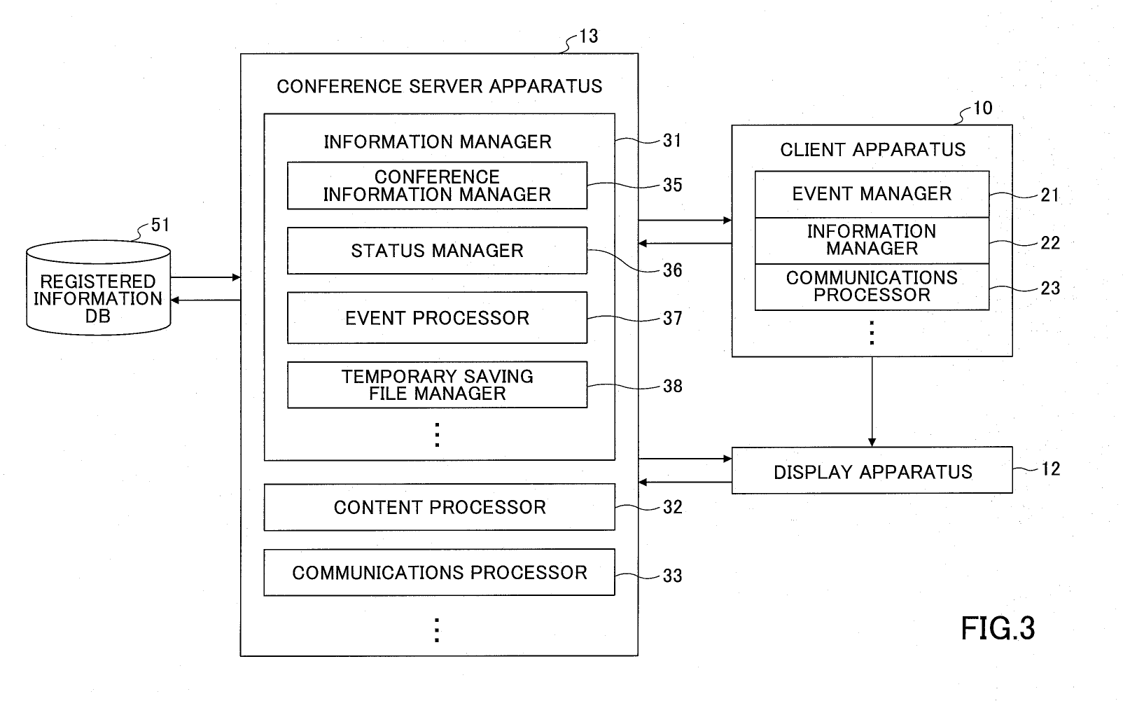

The conference system 1 according to the embodiment may be implemented by functional blocks illustrated, for example, in FIG. 3. FIG. 3 is a functional block diagram illustrating an example of the conference system according to the embodiment.

The client apparatus 10 is configured to implement an event manager 21, an information manager 22, and a communications processor 23 by executing programs such as a conference application.

The conference server apparatus 13 is configured to implement an information manager 31, a content processor 32, a communications processor 33, and the like by executing programs. The information manager 31 is configured to include a conference information manager 35, a status manager 36, an event processor 37, and a temporary saving file manager 38. The conference server apparatus 13 is connected to a registered information database (DB) 51.

Each of users using the conference system 1 activates a conference application installed in his/her client apparatus 10. The communications processor 23 of each client apparatus 10 establishes communications with the communications processor 33 of the conference server apparatus 13. The client apparatus 10 shares a screen with other client apparatuses 10 via the conference server apparatus 13.

This embodiment assumes a configuration that includes two or more client apparatuses 10, and one display apparatus 12. In the conference system 1, the screen displayed on the display apparatus 12 is shared between the client apparatuses 10. Further, in the conference system 1, operations performed on the shared screen displayed on the display apparatus 12 are synchronized by the client apparatuses 10.

When operations are performed on the shared screen, each of the client apparatuses 10 transmits information about the performed operations to the conference server apparatus 13. Each of the client apparatuses 10 receives from the conference server apparatus 13 information about operations performed on the shared screen by other client apparatuses 10.

The conference server apparatus 13 is configured to manage the client apparatuses 10 and control the screen shared between the client apparatuses 10. The information manager 31 of the conference server apparatus includes various types of processors such as a conference information manager 35, a status manager 36, an event processor 37, a temporary saving file manager 38, and the like.

The conference information manager 35 is configured to manage later-described conference information. The status manager 36 is configured to manage a conference status contained in the later-described conference information. The event processor 37 is configured to manage an event. The temporary saving file manager 38 is configured to manage a file, and the like saved in a temporary saving area.

Further, the conference server apparatus 13 is connected to a registered information DB 51 that accumulates information managed by the conference system 1. The registered information DB 51 is configured to store conference information of registered conferences, document information registered in the conferences, a conference status, and the like. When registering content items of documents, the registered information DB 51 is configured to store conference information of the documents registered in the conferences, document content items themselves, document sub-content items, full-text search data, version information, an editing status, and the like.

The display apparatus 12 includes functions similar to those of the client apparatus 10, and is configured not only to display input processes on the display apparatus 12 per se, but to reflect the events received from the client apparatus 10 in the display. Note that the content items displayed on the display apparatus 12 are transmitted to the conference server apparatus 13, and the transmitted content items are synchronized with the screens of the client apparatuses 10, while the transmitted content items are saved in the temporary saving area of the conference server apparatus 13.

When a user or an initial display of the default setting requests a mode suitable for allowing attendees of the conference to provide ideas to discuss the provided ideas (hereinafter called a “discussion mode”) while the conference is in progress, new conference content is created. Note that the new conference content in this case is a white image file. The new conference content is displayed on the display apparatus 12 such that the displayed new conference content matches the size of the screen of the display apparatus 12. The new conference content is also displayed on each of the client apparatuses 10 such that the displayed new conference content matches the size of a corresponding one of the client apparatuses 10 by the conference application.

When the user performs writing of characters or drawings on the new conference content in the display apparatus 12, the display apparatus 12 transmits operations information such as characters or drawings written on the new conference content to the conference server apparatus 13. The conference server apparatus 13 transmits the operations information received from the display apparatus 12 to the client apparatuses 10 to synchronize the transmitted operations information with the client apparatuses 10.

Similarly, when the user performs writing of characters or drawings on the new conference content in the client apparatus 10, the client apparatus 10 transmits operations information such as characters or drawings written on the new conference content to the conference server apparatus 13. The conference server apparatus 13 integrates operations information received from the client apparatuses 10 into the new conference content to reflect the new conference content having the integrated operations information to a display of the display apparatus 12.

Moreover, the user may also be able to perform editing such as selecting or deleting characters, drawings, or other objects already written on the new conference content in addition to writing characters or drawings. Such editing operations to characters, drawings, or other objects already written on the new conference content may also be synchronized and reflected between the client apparatuses 10 and the display apparatus 12 via the conference server apparatus 13.

Further, each user may also be able to transmit a file desired to be displayed on the new conference content from a corresponding one of the client apparatuses 10 to integrate the transmitted files as objects on the new conference content. The client apparatus 10 receives a request such as “transmit a file” selected from a menu from the user while displaying the new conference content, and receives selecting the file to be transmitted or newly creating a file.

The client apparatuses 10 transmits the corresponding file at selected timing of the file to be transmitted or saved timing of the newly created file. The conference server apparatus 13 converts the received files into an image files, or extracts the received files as text files, and integrate the converted files or the extracted files into the new conference content to reflect the new conference content having the integrated files onto the display of the display apparatus 12.

To select the file to transmit, the user may be able to select the file from the client apparatus 10, or select the file in storage accessible from the client apparatus 10. To create a new file to transmit, the user selects a type of the new file and a method of creating the new file when selecting “creating a new file” to create a new file.

For example, the user may be able to create a new file as a file to transmit. Examples of such new files include an image file of a picture that the user has taken by the built-in camera 509, an image file of a drawing that the user has created by a raster graphics editor, and a text file the user has created by a note pad.

The client apparatus 10 transmits the file with attached information to identify a sender to the conference server apparatus 13. The information to identify a sender may be a user's account when user information is managed. When the user information is not managed, the information to identify a sender may be information identifying the client apparatus 10 such as a machine name of the client apparatus 10 that has transmitted the file or transmitted date and time.

Using the above-described functions, the users increasingly attach or write their ideas or notes as objects onto the new conference content. For example, each user may be able to attach a previously created graphic image or a note to the new conference content by selecting a file of the previously created graphic image or a note to transmit the file to the conference server apparatus 13.

Further, the user may be able to attach handheld materials or hand-written ad-lib ideas on paper to the new conference content by taking a picture of the materials or hand-written paper and selecting a file of the picture to transmit the files to the conference server apparatus 13. In addition, the user may be able to attach a digital file to the new conference content by creating the digital file using an application such as a raster graphics editor to transmit the created file to the conference server apparatus 13.

The users may be able to organize their ideas while discussing their ideas by writing, drawing, and editing such as moving or grouping the objects attached to the new conference content, deleting unnecessary objects, adding or writing connecting lines between highly related objects.

When ending the organization of ideas, the user requests “save” of the organized ideas from the menu to cause the conference server apparatus 13 to save the new conference content that displays the organized ideas. The conference server apparatus 13 may save the new conference content that displays the organized ideas when the conference ends.

Hence, the conference system 1 according to the embodiment may be able to electronically implement a conference (i.e., implement an electronic conference) similar to a non-electronic conference in which two or more users are able to provide their ideas on post-it stickers attached to the whiteboard and discuss their ideas by moving or grouping the post-it stickers, and additional writing of ideas on the white board.

In the conference system 1 according to the embodiment that is applied to a conference method such as brainstorming in which attendees of a conference provide ideas to discuss the provided ideas, the users may be able to continue the discussion on the ideas from a desired version of the new conference content after it is saved. In addition, the users may be able to return to the ideas already discussed a short time ago to discuss the ideas again in the middle of the discussion by saving intermediate versions of the new conference content as required to manage versions of the new conference content. In the conference system 1 according to the embodiment, since the screen is shared by the users (attendees of a conference), it may be possible to easily implement a conference method, such as brainstorming in which attendees of a conference provide ideas to discuss the provided ideas, for remote users (attendees).

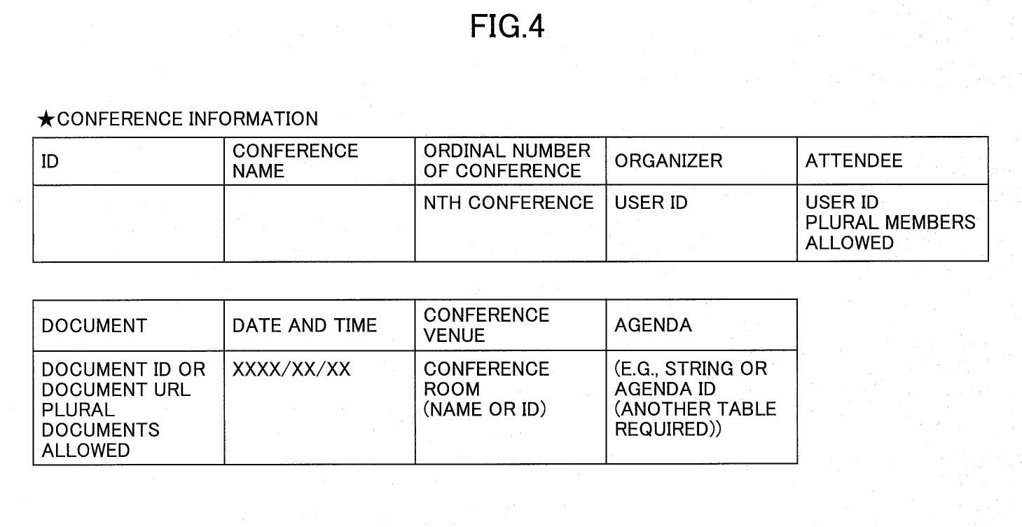

FIG. 4 is a configuration diagram illustrating an example of conference information stored in a registered information DB. The conference information of FIG. 4 includes as items an ID, a conference name, the number of conferences (i.e., the ordinal number of target conference), the organizer, attendees, documents, date and time, a conference venue, and an agenda.

The ID is information identifying a conference such as a conference ID. The conference name and the number of conferences are information by which users identify a conference such as the name of the conference and the ordinal number of the conference. The organizer is information identifying the organizer of the conference such as a user ID. The attendee is information identifying attendees at the conference such as a user ID. Two or more user IDs may be set in the attendee. The document is information identifying documents registered in the conference such as a document ID or a document URL. Two or more document IDs or document URLs may be set in the document. The date and time are date and time for convening the conference. The conference venue is information identifying a virtual conference room such as the name or ID of the conference room. The agenda is information such as an agenda of the conference, which is expressed by a character string or an agenda ID.

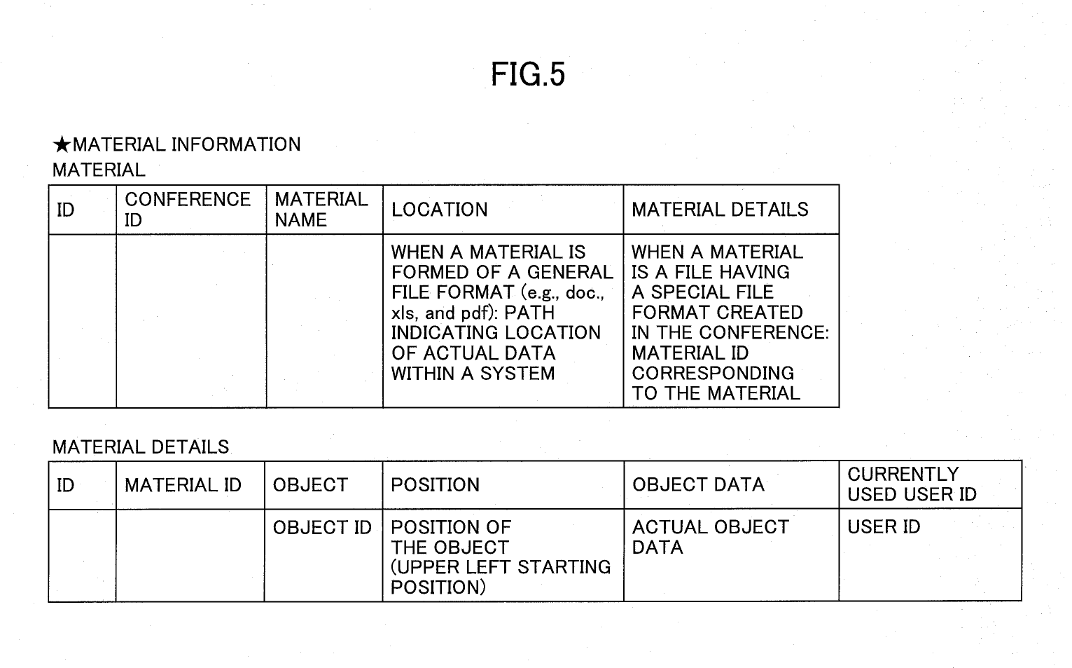

FIG. 5 is a configuration diagram illustrating an example of material information stored in the registered information DB. The material information of FIG. 5 includes a material table and a material details table. The material table includes as items an ID, a conference ID, a material name, a location, and material details. The ID is information identifying a document such as a document ID. The conference ID is information identifying a conference in which documents are registered such as a conference ID.

The material name is information by which users identify materials. An example of information identifying the material name may be the name of a document. The location is information identifying the location within the conference system 1 where actual data of the document are stored. An example of such information identifying the location may be a path. The material details are information identifying material details corresponding to the new conference content such as a material details ID when a document is new conference content.

The material details table includes as items an ID, a material ID, an object, a position, object data, and a currently used user ID. The ID is information identifying material details such as a material details ID. The material ID is information identifying a corresponding one of new conference contents such as a document ID.

The object is information identifying an object such as an object ID. The position is information identifying the position of an object such as the upper left starting position. The object data are information identifying actual data of the object. Further, the currently used user ID is information identifying a user currently using the object such as a user ID. The objects on the new conference content are exclusively controlled such that the objects accept operations from the users having user IDs that are set as the currently used ID. Note that the user IDs set as the currently used user ID are deleted when operations on the objects end.

FIG. 5 illustrates an example where an object displayed on the new conference content have actual data, and the actual data of the object are displayed at the position on the new conference content that is identified by the item “position”. Note that in the conference system 1 according to the embodiment, the shape, color, drawing strokes, and position of the object may be saved in advance in the material details table of FIG. 5, and the object is generated when displayed on the new conference content.

### Process Image

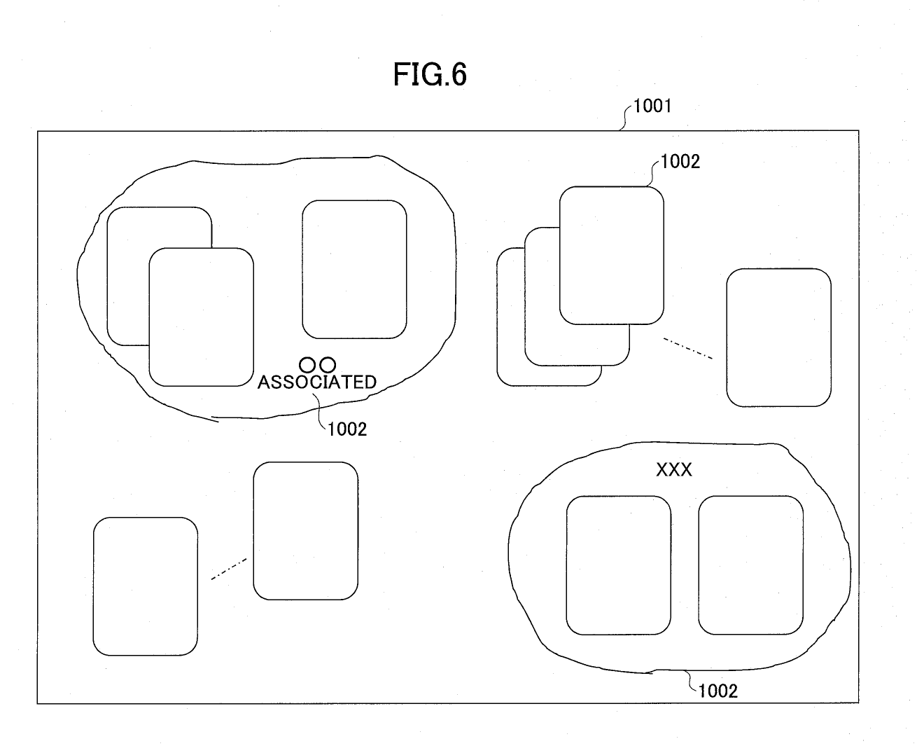

FIG. 6 is an image diagram illustrating an example of a display of new conference content. For example, new conference content 1001 is displayed on the display apparatus 12, or the like. The new conference content 1001 is an image file with a blank background. The new conference content 1001 displays files transmitted from the client apparatus 10 or objects 1002 such as characters or drawings input in the client apparatus 100.

Hence, the new conference content 1001 displays as objects 1002 input characters or drawings in addition to the files. Note that although characters or drawings are not allowed to be written into the files per se that are transmitted from the client apparatus 10 in the new conference content 100, characters or drawings that are converted as objects 1002 of text or lines may be superimposed on the images of the files.

In a case where the new conference content 1001 is manipulated from two or more client apparatuses 10 or display apparatuses 12, simultaneous accesses or manipulations may be allowed. Note that an area selected by another user (when an object 1002 is selected, the selected area indicates the selected object 1002, and when an area is selected, the selected area includes all the objects 1002 within the selected area) is not allowed to be edited until the selected area is released (i.e., until manipulation of the selected area ends). That is, the area selected by another user is partially subject to exclusive access control. Further, in the file of the new conference content 1001 to be saved, various objects 1002 are disposed such that the objects 1002 are individually selected and manipulated.

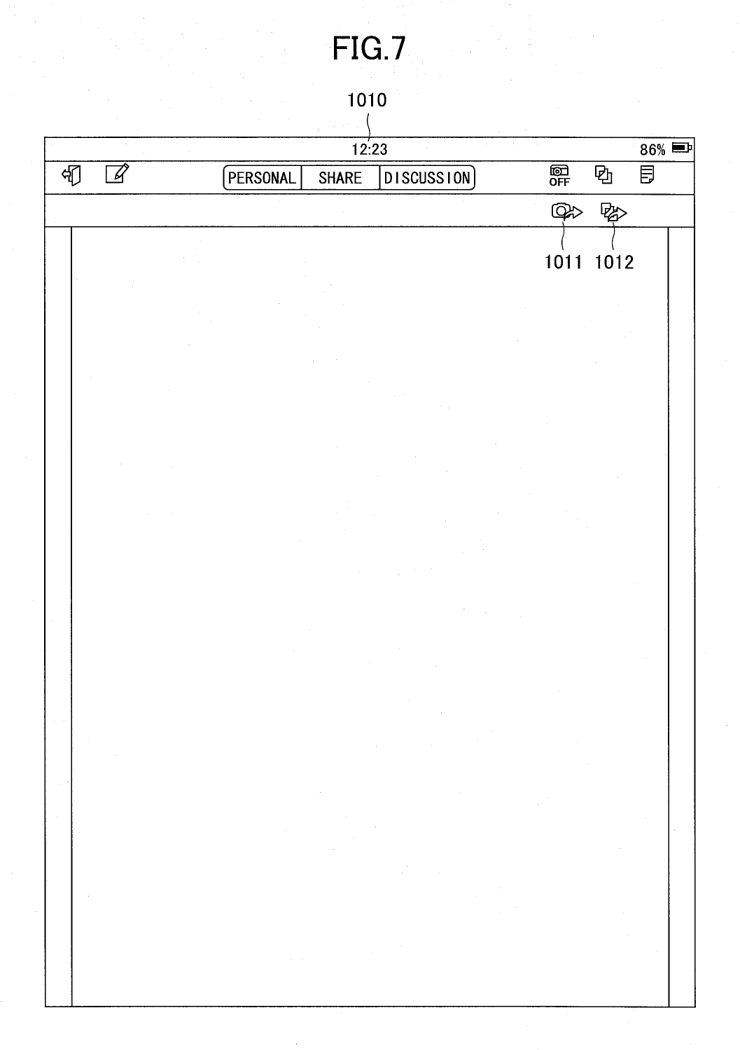

FIG. 7 is a screen image diagram illustrating a transmission process of a file that is desired to be displayed on the new conference content 1001. For example, as illustrated in FIG. 7, a camera activation button 1011 and a file selection button 1012 are displayed on a screen 1010 of the client apparatus 10. Hence, a user may be able to transmit a newly created file or a selected file to the conference server apparatus 13 by pressing the camera activation button 1011 or the file selection button 1012. The conference server apparatus 13 may be able to display the received file as an object 1002 on the new conference content 1001.

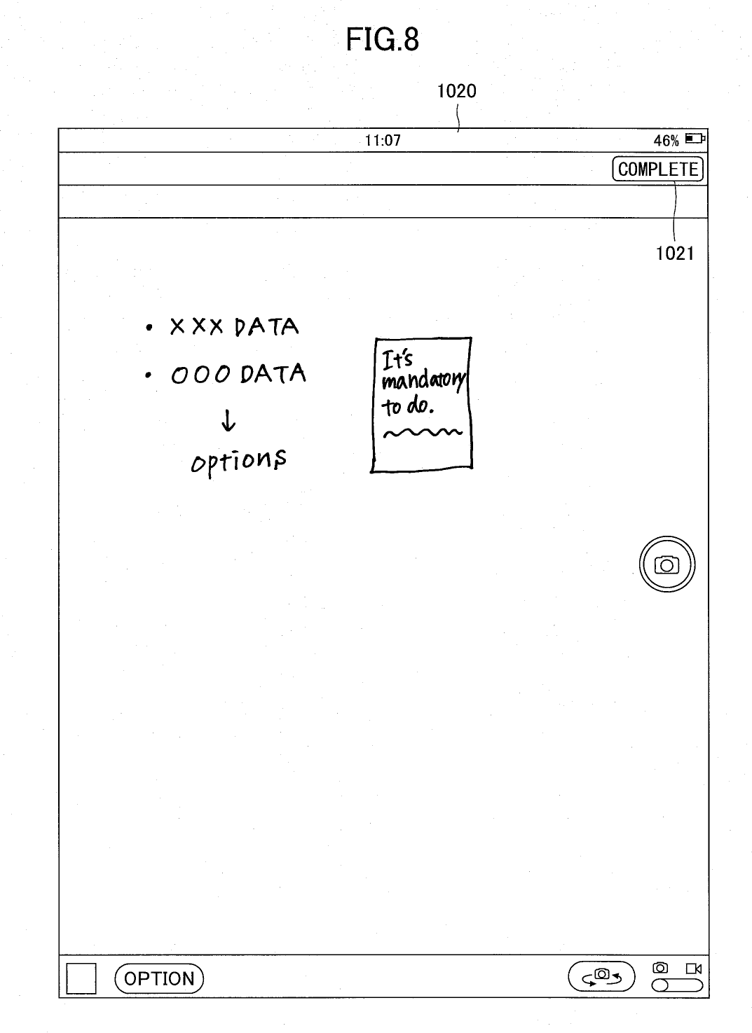

When the user presses the camera activation button 1011, the event manager 21 of the client apparatus 10 displays an imaged screen 1020 on the display apparatus 502. FIG. 8 is a screen image diagram illustrating an example of an imaged screen 1020. With this example, the user may be able to take a picture utilizing the camera 509 of the client apparatus 10 to transmit an image file of the picture to the conference server apparatus 13 as a newly created file by pressing a complete button 1021.

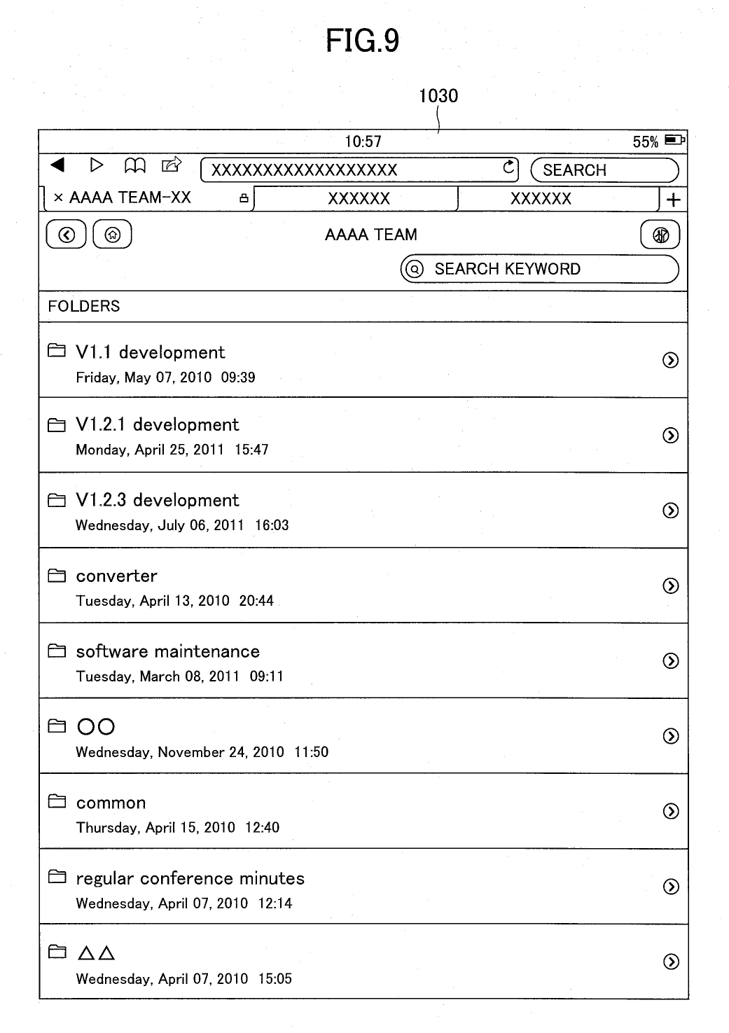

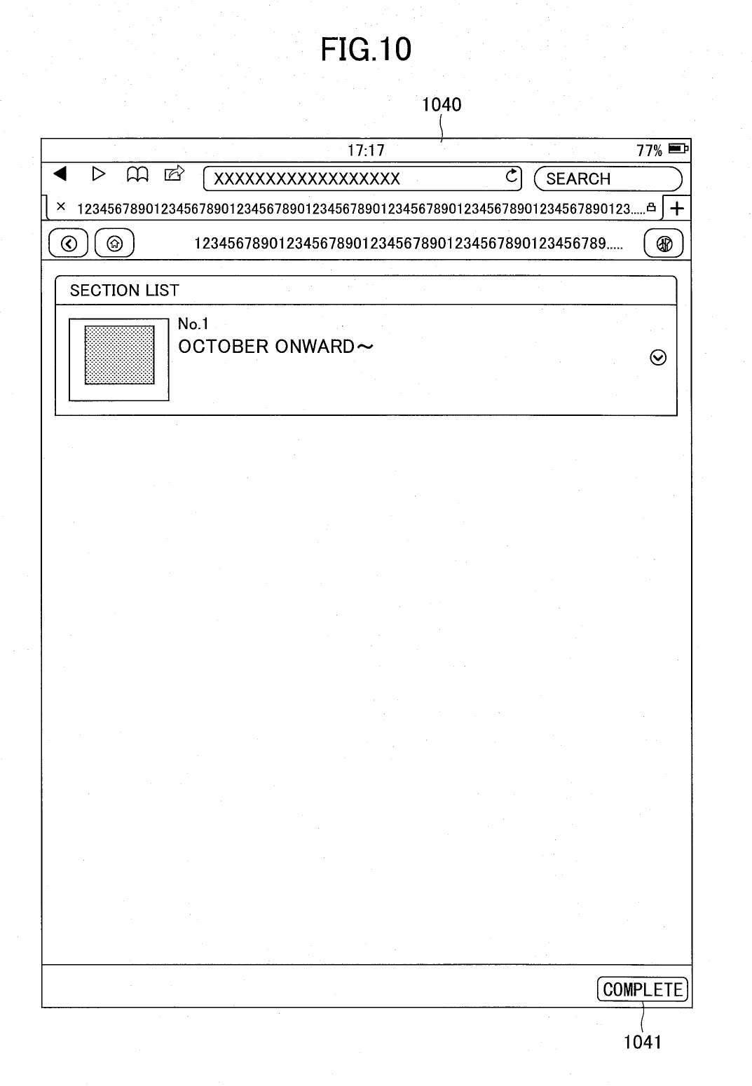

When the user presses the file selection button 1012, the information manager 22 of the client apparatus 10 displays a selection screen 1030 as illustrated in FIG. 9 or a selection screen 1040 as illustrated in FIG. 10 on the display apparatus 502. FIG. 9 is a screen image diagram illustrating an example of the selection screen 1030 for selecting a folder. FIG. 10 is a screen image diagram illustrating an example of the selection screen 1040 for selecting a file.

The user selects a folder from the selection screen 1030 in FIG. 9, and subsequently selects a file stored in the selected folder from the selection screen 1040 in FIG. 10. Thereafter, the user may be able to select a file from the selection screen 1040, and press a complete button 1041 to transmit the selected file to the conference server apparatus 13.

### Details of Process

In the following, details of a process of the conference system 1 according to an embodiment are described.

### Creating New Conference Content

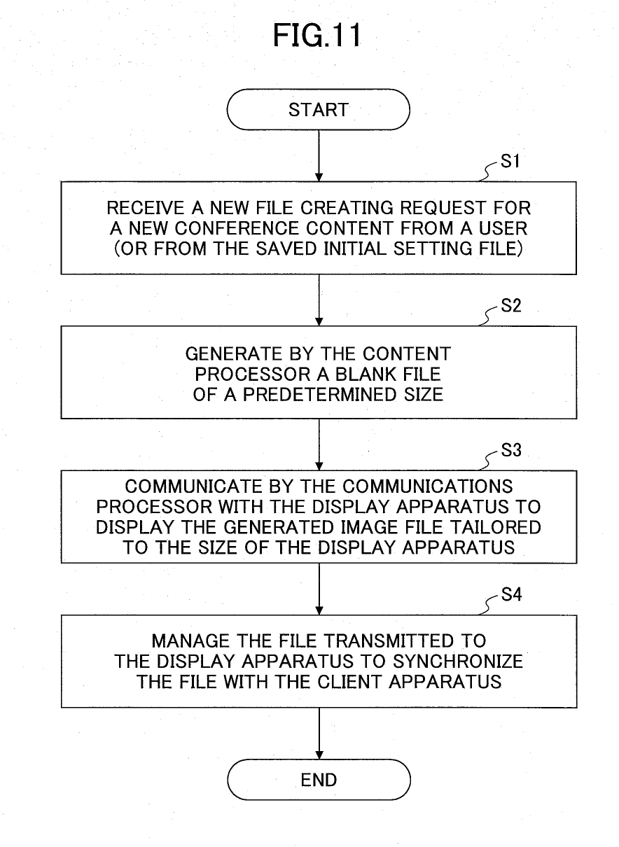

FIG. 11 is a flowchart illustrating an example of a process of creating new conference content. In step S1, the content processor 32 of the conference server apparatus 13 receives a new file creating request for new conference content from a user (or from the saved initial setting file).

In step S2, the content processor 32 generates a blank file (an image file) of a predetermined size. In step S3, a communications processor 33 of the conference server apparatus 13 communicates with the display apparatus 12 to display the generated image file that is tailored to the size of the display apparatus 12. In step S4, the temporary saving file manager 38 of the conference server apparatus 13 manages the image file transmitted to the display apparatus 12 to synchronize the image file with the client apparatus 10.

By following the process of the flowchart in FIG. 11, the conference server apparatus 13 generates the image file of the new conference content, and transmits the generated image file to the client apparatus 10 and the display apparatus 12 to synchronize these image files to be displayed.

### Transmission and Saving of Content Items in the Image File of the New Conference Content

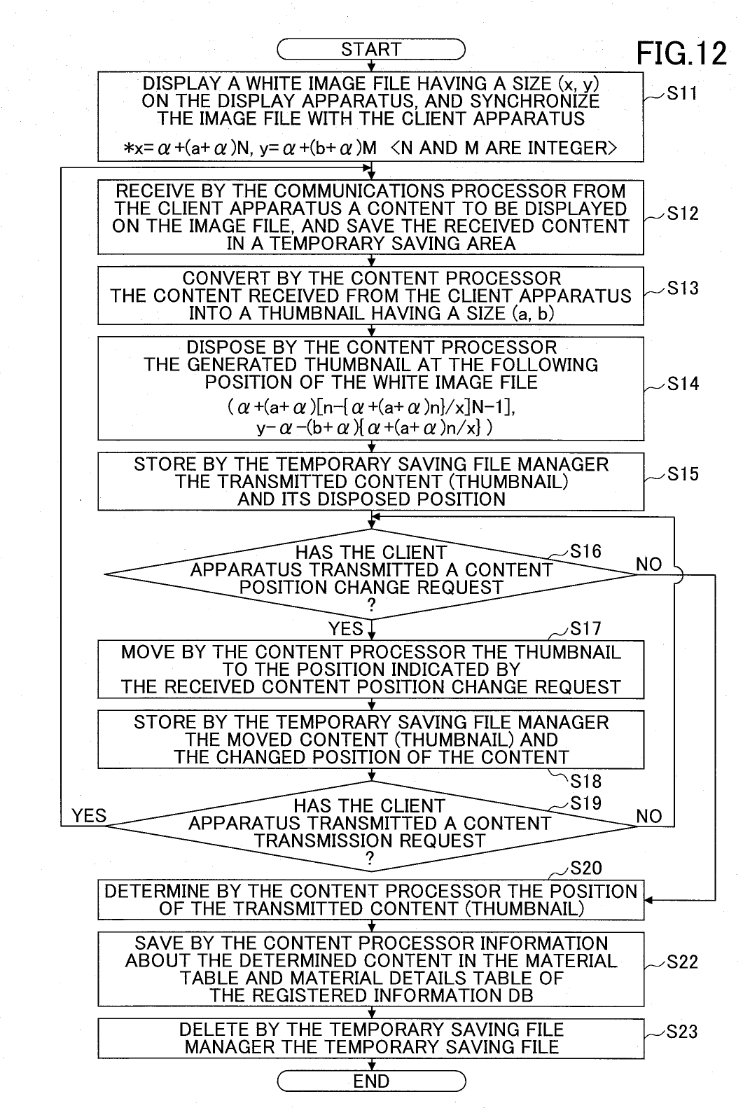

FIG. 12 is a flowchart illustrating an example of a transmission and saving process of content in the image file of the new conference content.

In step S11, the communications processor 33 of the conference server apparatus 13 causes the display apparatus 12 to display a white image file having a size (x, y), and synchronizes the image file with the client apparatus 10.

In step S12, the communications processor 33 of the conference server apparatus 13 receives from the client apparatus 10 content to be displayed on the image file of the new conference content, and saves the received content in a temporary saving area. In step S13, the content processor 32 of the conference server apparatus 13 converts the content received from the client apparatus 10 into a thumbnail having a size (a,

In step S14, the content processor 32 of the conference server apparatus 13 disposes the generated thumbnail at the following position of the image file of the new conference content.)

(α+(a+α)[n−{α+(a+α)n}/x]N−1], y−α−(b+α){α+(a+α)n/x}) (1)

In the above (1), a indicates padding between the content items (thumbnails), and n indicates the transmitted number of content items (the nth content items). Even when the already transmitted (disposed) content is moved, the default position of subsequently transmitted content is the position illustrated in (1). In step S15, the temporary saving file manager 38 of the conference server apparatus 13 stores the transmitted content (thumbnail) and the position at which the content is disposed.

In step S16, the content processor 32 of the conference server apparatus 13 determines whether the client apparatus 10 has transmitted content position change request. When the content processor 32 determines that the client apparatus 10 has transmitted the content position change request (“YES” in step in S16), the content processor 32 proceeds with step S17 to move the thumbnail to the position indicated by the received content position change request. In step S18, the temporary saving file manager 38 of the conference server apparatus 13 stores the moved content (thumbnail) and the changed position of the content.

In step S19, the content processor 32 of the conference server apparatus 13 determines whether the client apparatus 10 has transmitted content transmission request for content to he displayed on the image file of the new conference content. When the content processor 32 has determined that the client apparatus 10 has transmitted the content transmission request (“YES” in step S19), the communications processor 33 of the conference server apparatus 13 returns to step S12 to proceed with the process. When the content processor 32 has determined that the client apparatus 10 has not transmitted the content transmission request (“NO” in step S19), the communications processor 33 of the conference server apparatus 13 returns to step S16 to proceed with the process.

In step S16, when the content processor 32 of the conference server apparatus 13 determines that the client apparatus 10 has not transmitted content position change request (“NO” in step S16), the content processor 32 proceeds with step S20 to determine the position of the transmitted content (thumbnail).

In step S22, the content processor 32 of the conference server apparatus 13 saves information about the content the position of which is determined in the material table and the material details table of the registered information DB 51 of FIG. 5. In step S23, the temporary saving file manager 38 of the conference server apparatus 13 deletes the content stored in the temporary saving area and a temporary saving file storing the position of the content.

Note that in the flowchart of FIG. 12, the content items are displayed as the thumbnails having a predetermined size. However, the content items may be converted into the thumbnails according to the original sizes of the content items to dispose the thumbnails by computing the positions based on the sizes of the content items.

Further, in the flowchart of FIG. 12, padding (margin) is provided at a default position of the transmitted content to facilitate moving or grouping the content items. However, padding may be eliminated to dispose as many content items as possible.

Moreover, in the flowchart of FIG. 12, content items is sequentially disposed from top left to bottom right of the image file in consideration of moving directions of the content items. However, the content items may be disposed in other methods such as displaying the content items randomly. The content items may simultaneously be selected by selecting an area, or by simultaneously selecting two or more content items by pressing the “Shift” key and the “Ctrl” key. Note that the content items may be moved such that the content items are mutually superposed.

According to the flowchart of FIG. 12, the conference server apparatus 13 may be able to dispose the content items (thumbnails) on the image file of the new conference content and optionally change the positions of the content items.

### Addition and Saving of Drawing Objects in the Image File of the New Conference Content

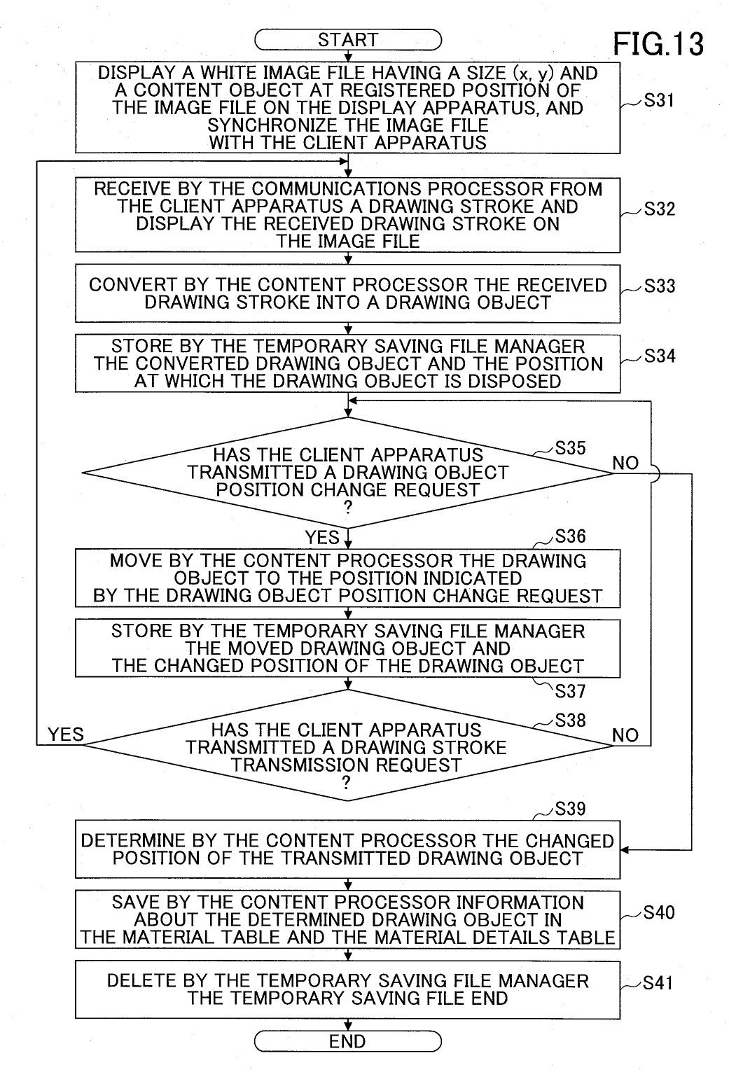

FIG. 13 is a flowchart illustrating an example of an addition and saving process of a drawing object in the image file of the new conference content. Note that in the following, the content items illustrated in FIG. 12 are described as content objects.

In step S31, the communications processor 33 of the conference server apparatus 13 causes the display apparatus 12 to display a white image file having a size (x, y) and content objects disposed in the image file, and synchronizes the image file with the client apparatus 10. Note that the position of the content object indicates the position in the image file determined in step S20 of FIG. 12.

In step S32, the communications processor 33 of the conference server apparatus 13 receives from the client apparatus 10 a drawing stroke to be displayed on the image file of the new conference content, and displays the received drawing stroke on the image file.

In step S33, the content processor 32 of the conference server apparatus 13 converts the received drawing stroke into a drawing object. In step S34, the temporary saving file manager 38 of the conference server apparatus 13 stores the converted drawing object and the position at which the drawing object is disposed.

In step S35, the content processor 32 of the conference server apparatus 13 determines whether the client apparatus 10 has transmitted a drawing object position change request. When the content processor 32 determines that the client apparatus 10 has transmitted the drawing object position change request (“YES” in step in S35), the content processor 32 proceeds with step S36 to move the drawing object to the position indicated by the drawing object position change request. In step S37, the temporary saving file manager 38 of the conference server apparatus 13 stores the moved drawing object and the changed position of the drawing object.

In step S38, the content processor 32 of the conference server apparatus 13 determines whether the client apparatus 10 has transmitted a drawing stroke transmission request for a drawing stroke to be displayed on the image file of the new conference content. When the content processor 32 has determined that the client apparatus 10 has transmitted the drawing stroke transmission request (“YES” in step S38), the communications processor 33 of the conference server apparatus 13 returns to step S32 to proceed with the process. When the content processor 32 has determined that the client apparatus 10 has not transmitted the drawing stroke transmission request (“NO” in step S38), the communications processor 33 of the conference server apparatus 13 returns to step S35 to proceed with the process.

In step S35, when the content processor 32 of the conference server apparatus 13 determines that the client apparatus 10 has not transmitted the drawing object position change request (“NO” in step in S35), the content processor 32 proceeds with step S39 to determine the changed position of the transmitted drawing object.

In step S40, the content processor 32 of the conference server apparatus 13 saves information about the drawing object the position of which is determined in the material table and the material details table of the registered information DE 51 of FIG. 5. In step S41, the temporary saving file manager 38 of the conference server apparatus 13 deletes the drawing object stored in the temporary saving area and a temporary saving file storing the position of the drawing object.

Note that in the flowchart of FIG. 13, the drawing object transmitted from the client apparatus 10 is illustrated; however, the drawing object may be a fixed object such as a square, a circle, or a line. When the drawing object is a fixed object such as a square, a circle, or a line, the process of converting the “received drawing stroke into a drawing object” in step S33 is changed to a process of generating the “fixed object”.

Further, the drawing objects may simultaneously be selected by selecting an area, or by simultaneously selecting two or more drawing objects by pressing the “Shift” key and the “Ctrl” key. The drawing objects may be moved such that the drawing objects are mutually superposed.

According to the flowchart of FIG. 13, the conference server apparatus 13 may be able to dispose the drawing objects on the image file of the new conference content and optionally change the positions of the drawing objects.

### Exclusive Control Over Operations with Respect to Object

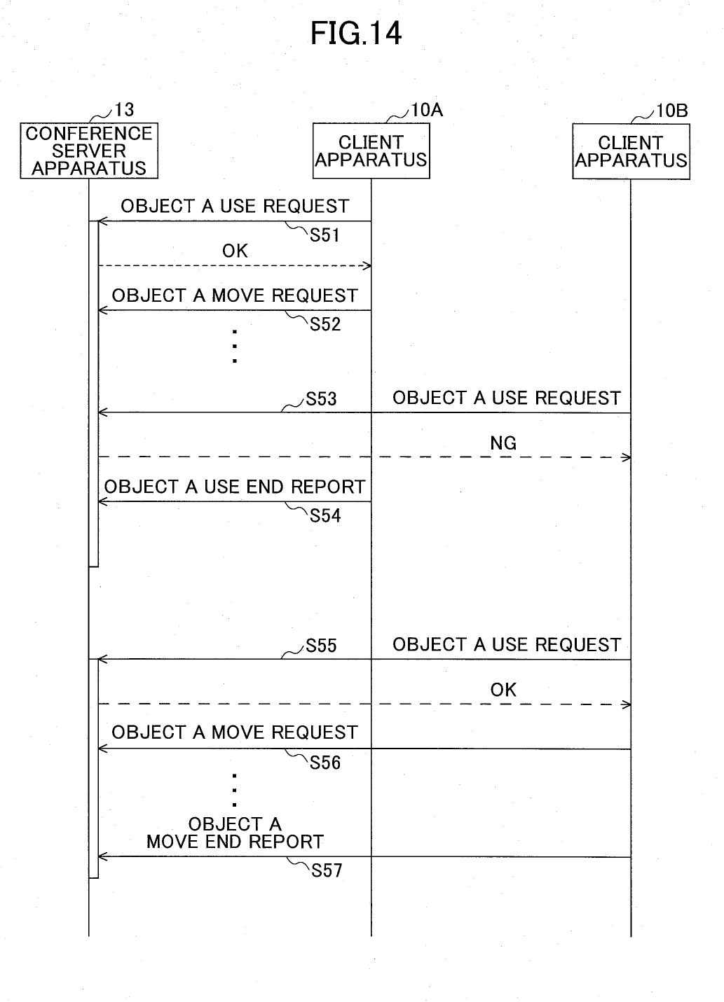

In the following, an illustration is given of exclusive control over operations with respect to an object such as content object or a drawing object. FIG. 14 is a sequence diagram illustrating an example of exclusive control over operations with respect to an object.

In step S51, a user operating a client apparatus 10A selects an object A to perform operations such as changing the position of the object A disposed on the image file of the new conference content.

The event manager 21 of the client apparatus 10A receives from the user the selection of the object A, and transmits via the communications processor 23 an object A use request to the conference server apparatus 13. The content processor 32 of the conference server apparatus 13 that has received the object A use request checks the item named “currently used user ID” of the material details table of FIG. 5 corresponding to the object A. When a user ID is not set in the “currently used user ID”, the content processor 32 sets a user ID of the client apparatus 10A in the item called “currently used user ID”, and responds with “OK” to the client apparatus 10A.

In step S52, the event manager 21 of the client apparatus 10A transmits via the communications processor 23, for example, an object A move request to the conference server apparatus 13 based on the user's operations.

The content processor 32 of the conference server apparatus 13 receives the object A move request because the user ID of the client apparatus 10A is set in the item called “currently used user ID” of the material details table of FIG. 5 corresponding to the object A.

Thereafter, in step S53, the user operating a client apparatus 10B selects the object A because the user operating the client apparatus 10B also performs operations such as changing the position of the object A. The event manager 21 of the client apparatus 10B receives from the user the selection of the object A, and transmits via the communications processor 23 an object A use request to the conference server apparatus 13. The content processor 32 of the conference server apparatus 13 that has received the object A use request checks the item named the “currently used user ID” of the material details table of FIG. 5 corresponding to the object A.

Since the user ID of the client apparatus 10A is set in the item called the “currently used user ID”, the content processor 32 responds with “NG” to the client apparatus 10B.

Thus, the object disposed on the image file of the new conference content may be under exclusive control such that only operations by the user having the user ID set in the “currently used use ID” of the material details table are accepted.

When the operations performed on the object A end, the event manager 21 of the client apparatus 10A transmits via the communications processor 23 an object A use end report to the conference server apparatus 13. The content processor 32 of the conference server apparatus 13 that has received the object A use end report deletes the user ID of the client apparatus 10A from the item called the “currently used user ID” of the material details table of FIG. 5 corresponding to the object A.

Thereafter, in step S55, the user operating the client apparatus 10B selects the object A because the user operating the client apparatus 10B also performs operations the position of the object A. The event manager 21 of the client apparatus 10B receives from the user the selection of the object A, and transmits via the communications processor 23 an object A use request to the conference server apparatus 13.

The content processor 32 of the conference server apparatus 13 that has received the object A use request checks the item named the “currently used user ID” of the material details table of FIG. 5 corresponding to the object A. Since a user ID is not set in the “currently used user ID”, the content processor 32 sets a user ID of the client apparatus 10B in the item called “currently used user ID”, and responds with “OK” to the client apparatus 10B.

In step S56, the event manager 21 of the client apparatus 10B transmits via the communications processor 23, for example, an object A move request to the conference server apparatus 13 based on the user's operations.

The content processor 32 of the conference server apparatus 13 receives the object A move request because the user ID of the client apparatus 10B is set in the item called “currently used user ID” of the material details table of FIG. 5 corresponding to the object A.

Then, in step S57, when the operations performed on the object A end, the event manager 21 of the client apparatus 10B transmits via the communications processor 23 an object A use end report to the conference server apparatus 13.

The content processor 32 of the conference server apparatus 13 that has received the object A use end report deletes the user ID of the client apparatus 10B from the item called the “currently used user ID” of the material details table of FIG. 5 corresponding to the object A.

As illustrated based on the sequence diagram of FIG. 14, in the conference system 1 according to the embodiment may be able to perform exclusive control over the operations, such as changing the position of an object, for each of the objects disposed in the new conference content.

### SUMMARY

The conference system 1 according to the embodiment is configured to display a white image file on the display apparatus 12 in place of a white space of a whiteboard. In the conference system 1 according to the embodiment, each user may be able to have a discussion with other users while displaying content items on the white image file from the client apparatus 10, displaying characters or drawings, moving the content items, grouping the content items, and the like.

The conference system 1 according to the embodiment may be able to electronically implement a conference similar to a non-electronic conference in which two or more users are able to provide their ideas on post-it stickers attached to the whiteboard and discuss their ideas by moving or grouping the post-it stickers, and additional writing of ideas on the white board.

The above-described embodiment may provide an information processing system, an information processing apparatus, and a non-transitory recording medium storing a program that are suitable for allowing two or more users to provide information to discuss the information provided.

The present invention is not limited to examples or embodiments disclosed above. Various modifications or alteration may be made without departing from the scope of the claims of the present invention.

For example, a display apparatus disclosed in the claims corresponds to the display apparatus 12. An operations terminal corresponds to the client apparatus 10. An information processing apparatus corresponds to the conference server apparatus 13. Image data on which at least one object is disposed correspond to an image file of the new conference content. A display controller, a display update unit, and an object receiver correspond to the content processor 32. An information manager corresponds to an information manager 31.

Note that the conference system 1 illustrated in FIG. 1 is merely an example. Various examples of system configurations may be provided depending on the purpose or the intended use.

The present invention can be implemented in any convenient form, for example using dedicated hardware, or a mixture of dedicated hardware and software. The present invention may he implemented as computer software implemented by one or more networked processing apparatuses. The network can comprise any conventional terrestrial or wireless communications network, such as the Internet. The processing apparatuses can compromise any suitably programmed apparatuses such as a general purpose computer, a personal digital assistant, a mobile telephone (such as a WAP or 3D-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, a hard disk, a CD ROM, a magnetic tape device or a solid state memory device.

The hardware platform includes any desired kind of hardware resources including, for example, a central processing unit (CPU), a random access memory (RAM), and a hard disk drive (HDD). The CPU may be implemented by any desired kind of any desired number of processors. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible In this example, the CPU, such as a cache memory of the CPU, and the RAM may function as a physical memory or a primary memory of the apparatus, while the HDD may function as a secondary memory of the apparatus.

The present invention is not limited to the specifically disclosed embodiments, and variations and modifications may be made without departing from the scope of the present invention.

The present application is based on Japanese Priority Application No. 2013-175785 filed on Aug. 27, 2013, the entire contents of which are hereby incorporated herein by reference.

What is claimed is:

1. An information processing apparatus connected via a network to a display apparatus and one or more operations terminals, the information processing apparatus, comprising:
a display controller configured to transmit to the display apparatus and the operations terminals image data in which at least one object is disposed and display the transmitted image data on the display apparatus and the operations terminals;
an information manager configured to manage information of the objects; and
a display update unit configured to update a display of the objects disposed in the image data by receiving operations with respect to the objects from the operations terminals and updating the objects based on the received operations.

2. The information processing apparatus as claimed in claim 1, further comprising:
an object receiver configured to receive the objects from the operations terminals and update the information of the objects such that the received objects are disposed in the image data.

3. The information processing apparatus as claimed in claim 1, wherein
the display update unit that has accepted operations with respect to the objects from one of the operations terminals does not accept operations with respect to the objects from other operations terminals until the one of the operations terminals ends the operations with respect to the objects.

4. The information processing apparatus as claimed in claim 1, wherein
the information manager independently stores each of the objects disposed in the image data.

5. The information processing apparatus as claimed in claim 1, wherein
the information manager saves information of the updated objects as required to manage versions of the saved information.

6. The information processing apparatus as claimed in claim 1, wherein
each of the objects is content object or a drawing object.

7. The information processing apparatus as claimed in claim 1, wherein
the operations with respect to the objects disposed in the image data include moving the objects.

8. An information processing system connected via a network to a display apparatus, one or more operations terminals, and an information processing apparatus, the information processing system comprising:
a display controller configured to transmit to the display apparatus and the operations terminals image data in which at least one object is disposed and display the transmitted image data on the display apparatus and the operations terminals;
an information manager configured to manage information of the objects; and
a display update unit configured to update a display of the objects disposed in the image data by receiving operations with respect to the objects from the operations terminals and updating the objects based on the received operations.

9. An information processing method of an information processing apparatus, the information processing apparatus being connected via a network to a display apparatus and one or more operations terminals, the information processing method, comprising:
transmitting to the display apparatus and the operations terminals image data in which at least one object is disposed and display the transmitted image data on the display apparatus and the operations terminals;
managing information of the objects; and
updating a display of the objects disposed in the image data by receiving operations with respect to the objects from the operations terminals and updating the objects based on the received operations.

10. The information processing method as claimed in claim 9, further comprising:
receiving the objects from the operations terminals and updating the information of the objects such that the received objects are disposed in the image data.

11. The information processing method as claimed in claim 9, wherein
when operations with respect to the objects from one of the operations terminals have been accepted, operations with respect to the objects from other operations terminals are not accepted until the one of the operations terminals ends the operations with respect to the objects.

12. The information processing method as claimed in claim 9, wherein
each of the objects disposed in the image data is independently stored.

13. The information processing method as claimed in claim 9, wherein
information of the updated objects is saved as required to manage versions of the saved information.

14. The information processing method as claimed in claim 9, wherein
each of the objects is content object or a drawing object.

15. The information processing method as claimed in claim 9, wherein
the operations with respect to the objects disposed in the image data include moving the objects.
